(19) United States
(12) Patent Application Publication
(10) Pub. No.: US 2008/0273023 A1
(43) Pub. Date: Nov. 6, 2008

(54) DISPLAY ELEMENT DRIVE METHOD, DISPLAY ELEMENT AND ELECTRONIC TERMIAL

(75) Inventors: Masaki NOSE, Kawasaki (JP); Tomohisa SHINGAI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/173,404

(22) Filed: Jul. 15, 2008

Related U.S. Application Data
(63) Continuation of application No. PCT/JP2006/300451, filed on Jan. 16, 2006.

(51) Int. Cl. G09G 5/00; G09G 3/36

(52) U.S. Cl. 345/205; 345/87

(57) ABSTRACT

The embodiment relates to a display element drive method performing write at a low speed for still image display and in particular, to a method for driving a display element using cholesteric liquid crystal (electronic paper). The display element includes a plurality of scan electrodes and data electrodes intersecting one another in the opposed state. The drive method executes an empty scan for the scan electrodes before performing an image write process. The scan electrodes are selected in a predetermined sequence and an image write process is performed. According to the drive method, it is possible to suppress a large inrush current generated immediately after the image write. Moreover, it is possible to use a cheap general-purpose driver, apply the method to a cell-less display device, and achieve power saving and a stable display quality.

### CROSS-REFERENCE TO RELATED APPLICATION

This application is a continuation application and is based upon PCT/JP2006/300451, filed on Jan. 16, 2006.

### BACKGROUND

The embodiment relates to a display element drive method, a display element and an electronic terminal, or in particular, to a technique for driving the display elements used for a still image display including the cholesteric liquid crystal.

In recent years, research organizations of various enterprises and universities have vigorously made efforts to develop electronic paper. The electronic paper is expected to find a great variety of applications primarily in electronic books, and other fields such as subdisplays of mobile terminals and IC card display devices.

The cholesteric liquid crystal is known as a promising material of the electronic paper. The cholesteric liquid crystal has superior features including a semi-permanent display holdability (memorability), a bright color display, a high contrast and a high resolution. Further, the cholesteric liquid crystal is capable of bright full-color display by lamination of display layers for exhibiting the reflected colors of RGB, respectively.

With the cholesteric liquid crystal, the memorability makes possible an inexpensive, simple matrix drive and the display size as large as A4 or more, for example, can be realized with comparative ease. The cholesteric liquid crystal consumes power only when updating the display contents (rewriting the image), and once the image has been rewritten completely, the image is held even after power is turned off.

First, an example of drive operation of the cholesteric liquid crystal is explained taking the display element according to this embodiment as an example.

FIGS. 1A, 1B are diagrams for explaining the orientation of the cholesteric liquid crystal, in which FIG. 1A shows the planar state and the FIG. 1B the focal conic state.

The cholesteric liquid crystal can assume two stable states of the planar state and the focal conic state without any electric field.

Specifically, as shown in FIG. 1A, in the planar state, the incident light is reflected on the liquid crystal, and therefore, visible to human eyes.

In the focal conic state, on the other hand, the incident light is transmitted through the liquid crystal as shown in FIG. 1B. By forming a light absorption layer in addition to the liquid crystal layer, the black color can be displayed in the focal conic state.

In the planar state, the light of a wavelength corresponding to the spiral pitch of the liquid crystal molecules is reflected, and the wavelength λ associated with the maximum reflection is given as λ=n·p, where n is the average refractive index of the liquid crystal and p the spiral pitch. Incidentally, the reflection band Δλ increases with the refractive index anisotropy Δn.

FIGS. 2A, 2B and 2C are diagrams showing the voltage characteristic (relation between time and voltage) for driving the cholesteric liquid crystal, and show the electric field applied to the liquid crystal with the change in the homeotropic state, the focal conic state and the planar state. The homeotropic state is designated as H, the focal conic state as FC and the planar state as P.

First, upon application of a strong electric field to the cholesteric liquid crystal, the spiral structure of the liquid crystal molecules is completely loosened into the homeotropic state in which all the molecules are arranged in the direction of the electric field.

In the case where the electric field is reduced to zero suddenly from the homeotropic state as shown in FIG. 2B, the spiral axis of the liquid crystal assumes the position perpendicular to the electrodes into the planar state P in which the light is selectively reflected in accordance with the spiral pitch.

In the case where an electric field so weak as to loosen the spiral axis of the liquid crystal molecules with difficulty is removed after being formed as shown in FIG. 2A, or in the case where a strong electric field is formed and slowly removed as shown in FIG. 2C, then, the spiral axis of the liquid crystal assumes the direction parallel to the electrodes into the focal conic state in which the incident light is transmitted.

In the case where an electric field of an intermediate strength is applied and suddenly removed, on the other hand, the liquid crystals in planar state P and focal conic state FC come to coexist, thereby making possible the halftone color display.

As described above, the cholesteric liquid crystal is bistable, and therefore, by utilizing this phenomenon, the information can be displayed.

FIG. 3 is a diagram showing the reflectivity characteristic (relation between voltage and reflectivity) of the cholesteric liquid crystal, and collectively illustrates the voltage response characteristic of the cholesteric liquid crystal explained with reference to FIGS. 2A to 2C.

As shown in FIG. 3, in the case where the initial state is the planar state P (extreme left portion of FIG. 3 where reflectivity is high), an increase in the pulse voltage into a certain range comes to assume a drive band for the focal conic state FC (portion of FIG. 9 where reflectivity is low) and a further increase of the pulse voltage again assumes a drive band for the planar state P (extreme right portion where voltage is high).

In the case where the initial state is the focal conic state FC (extreme left portion where reflectivity is low), on the other hand, the drive band for the planar state P comes to be gradually assumed with the increase in pulse voltage.

Incidentally, in the planar state P, only the right circularly polarized light or the left circularly polarized light is reflected, and the remaining circularly polarized light is transmitted. Therefore, the theoretical maximum value of reflectivity is 50%.

The conventional multiplex drive method for an element using the ferroelectric liquid crystal has been proposed in which the voltage variation of the high-frequency AC waveform due to the effect of the signal electrode waveform in the nonselect period is removed by the synthetic waveform applied to the liquid crystal element, so that a low voltage is used for drive operation thereby to reduce the driver cost (for example, see JP-S63-29353-A). In Patent Document 1, the “nonselect” period is defined as a “nonselect pixel” (synchronized with the write operation) in the write operation and not in the phase (unsynchronized) completely independent of the write operation.

Further, the conventional drive method for the liquid crystal element having a memorability has been proposed in which a superior contrast can be maintained over a long period of time by applying an erasing pulse out of the select period in order to assure the uniform orientation of the liquid crystal (for example, see JP-H07-140443-A). In Patent Document 2, the “erasing pulse applied out of the select period”, which is a reset pulse for assuring the uniform orientation of the liquid crystal, is applied in synchronism with the image write operation and not intended to suppress the extraneous power consumption out of synchronism with the image write operation.

As described above, the electronic paper has come to find practical applications using the cholesteric liquid crystal, for example, in recent years.

In many cases, the simple matrix drive with an inexpensive multipurpose driver is used for the electronic paper. This poses the problem that an excessive surge current is generated immediately after starting the image rewrite (write) operation by switching on power. This surge current greatly consumes the battery, and further, may increase beyond the current supplied by the battery, thereby sometimes stopping the rewrite operation or causing a malfunction.

We have vigorously studied in search of the cause of an excessive surge current flowing immediately after starting to rewrite the image by switching on power, and have made it clear that the shift register of the scan-side driver becomes unstable and selects extraneous electrodes after power is switched on.

FIGS. 4A and 4B are diagrams for explaining the problem in the conventional display element drive method. Incidentally, FIG. 4A shows an example of an image thus far displayed, and FIG. 4B schematically shows the state immediately after starting to rewrite the image by switching on power.

In the prior art, the multipurpose driver used for the STN (Super Twisted Nematic) liquid crystal display element, for example, is normally used for displaying a dynamic image, and therefore, in the case where the shift register of the scan-side driver (scan driver) becomes unstable and selects extraneous electrodes, the scanning of the first frame with the extraneous electrodes selected poses no problem since the surge current flows only for a very short time.

As shown in FIG. 4B, for example, assume that the multipurpose driver is used for the display element of a still image such as the electronic paper formed of the cholesteric liquid crystal. The scan rate for the electronic paper is so low (about one second required to scan one frame, for example) that the scanning time with the extraneous electrodes selected is lengthened and a large current (surge current) flows.

In the case where the image rewrite operation is started by switching on power, the shift register of the scan-side multipurpose driver becomes unstable and extraneous electrodes as many as about one third of all the scan electrodes are selected. In the process, a current (surge current) as large as several hundred milliamperes flows.

This phenomenon of the selection of extraneous electrodes attributable to the use of the multipurpose driver occurs not only in the case where the power supply of the electronic paper or the like is actually switched on but also in the case where the image is rewritten with the power on. In the latter case, the same phenomenon occurs, for example, in the case where the power supply for the multipurpose is cut off while the previous image is displayed, and the power is supplied again to the multipurpose driver when rewriting the image. Specifically, in the case where the power supply once cut off is supplied again to the scan driver, for example, the shift register of the scan drive becomes unstable and extraneous electrodes selected, with the result that a large surge current flows.

The above-mentioned surge current flowing at the time of switching on power is especially large for a large-sized display such as A4 or poster size. In such case, the problem is posed in which the surge current makes it difficult to drive the battery or display irregularities are generated due to an unstable drive voltage.

### SUMMARY OF THE EMBODIMENTS

According to an aspect of the embodiment, there is provided a method of driving a display element including a plurality of scan electrodes and a plurality of data electrodes intersecting in opposed relation to each other for selecting the scan electrodes in a predetermined order and executing an image writing process, wherein an empty scan process for the scan electrodes is executed before the image writing process.

### BRIEF DESCRIPTION OF THE DRAWINGS

FIG. 1A is a diagram (part 1) for explaining the orientation of cholesteric liquid crystal;

FIG. 1B is a diagram (part 2) for explaining the orientation of cholesteric liquid crystal;

FIG. 2A is a diagram (part 1) showing the voltage characteristic for driving the cholesteric liquid crystal;

FIG. 2B is a diagram (part 2) showing the voltage characteristic for driving the cholesteric liquid crystal;

FIG. 2C is a diagram (part 3) showing the voltage characteristic for driving the cholesteric liquid crystal;

FIG. 3 is a diagram showing the reflectivity characteristic of the cholesteric liquid crystal;

FIG. 4A is a diagram (part 1) for explaining the problem of the conventional display element drive method;

FIG. 4B is a diagram (part 2) for explaining the problem of the conventional display element drive method;

FIG. 5A is a diagram (part 1) for explaining the principle of the display element drive method according to the embodiment;

FIG. 5B is a diagram (part 2) for explaining the principle of the display element drive method according to the embodiment;

FIG. 5C is a diagram (part 3) for explaining the principle of the display element drive method according to the embodiment;

FIG. 6 is a block diagram schematically showing an electronic terminal using a display element according to an embodiment;

FIG. 7 is a sectional view schematically showing an example of the display element shown in FIG. 6;

FIG. 8 is a flowchart for explaining an example of the display element drive method according to the embodiment;

FIG. 9 is a diagram showing a control signal in an example of the display element drive method according to the embodiment;

FIG. 10 is a diagram for explaining the scan pulse signal in the display element drive method according to the embodiment;

FIG. 11A is a diagram (part 1) for explaining the scan driver according to a second embodiment;

FIG. 11B is a diagram (part 2) for explaining the scan driver according to a second embodiment;

FIG. 12A is a diagram (part 1) for explaining the scan driver according to a third embodiment;

FIG. 12B is a diagram (part 2) for explaining the scan driver according to a third embodiment;

FIG. 13 is a diagram for explaining the scan driver according to a fourth embodiment;

FIG. 14 is a diagram for explaining for explaining the scan driver according to a fifth embodiment;

FIG. 15 is a diagram showing an example of the display element according to the embodiment; and

FIG. 16 is a block diagram schematically showing an electronic terminal using the display element according to another embodiment.

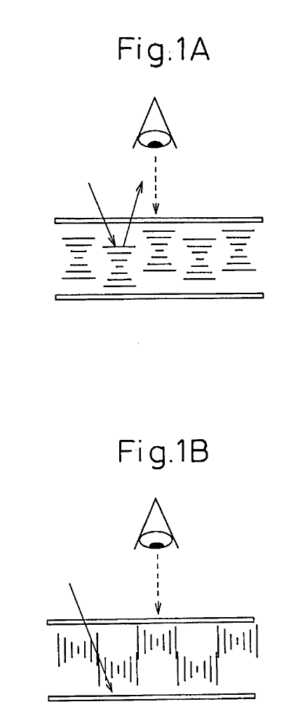

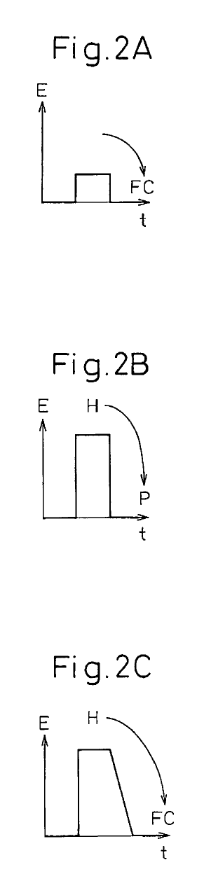

### DETAILED DESCRIPTION OF THE EMBODIMENTS

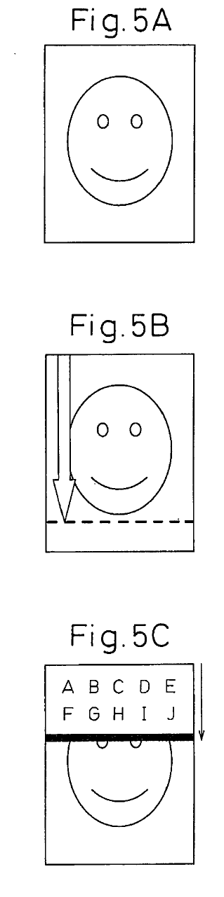

First, the principle of the display element drive method according to the embodiment is explained with reference to FIGS. 5A to 5C. Incidentally, FIG. 5A illustrates an example of the image thus far displayed, and FIG. 5B schematically shows the manner in which the empty scanning is conducted immediately after starting the image write (rewrite) operation by switching on power. FIG. 5C shows the manner in which the image is actually written after the empty scan.

In the display element drive method according to the embodiment, as shown in FIG. 5B, the empty scanning process is executed for the scan electrodes before the image writing process, and then, as shown in FIG. 5C, the actual image writing process is executed.

As a result, the shift register of the scan driver is prevented from becoming so unstable that extraneous electrodes are selected, thereby preventing a large surge current from flowing.

Below, a display element drive method, a display element and an electronic terminal according to an embodiment are explained in detail with reference to the accompanying drawings.

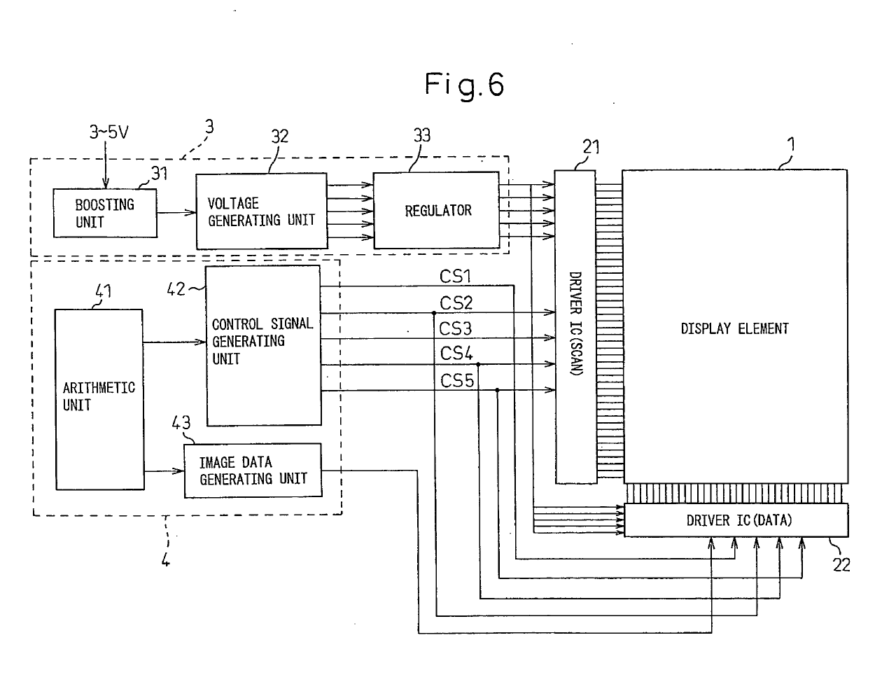

FIG. 6 is a block diagram schematically showing the electronic terminal (display device) using the display element according to an embodiment. In FIG. 6, reference numeral 1 designates a display element, numeral 3 a power supply circuit, numeral 4 a control circuit, numeral 21 a scan-side driver IC (scan driver), and numeral 22 a data-side driver IC (data driver). The scan driver 21 shown in FIG. 6 is the one according to a first embodiment, and has as many control terminals as the scan electrodes in the display element 1.

As shown in FIG. 6, the power supply circuit 3 includes a boosting unit 31, a voltage generating unit 32 and a regulator 33. The boosting unit 31 receives an input voltage of about +3 to +5 V, for example, from a battery, and boosts it to and supplies a voltage for driving a display medium (display element 1) to the voltage generating unit 32. The voltage generating unit 32 generates a voltage required for each of the scan driver 21 and the data driver 22, while the regulator 33 stabilizes and supplies the voltages from the voltage generating unit 32 to the scan driver 21 and the data driver 22.

The control circuit 4 includes an arithmetic unit 41, a control data generating unit 42 and an image data generating unit 43. The arithmetic unit 41 calculates the image data and the control signal supplied from an external source. The image data is supplied to the data driver 22 as a data suitable for the display element 1 through the image data generating unit 43. The control signal, on the other hand, is supplied to the scan driver 21 and the data driver 22 through the control signal generating unit 42 as various control signals suitable for the display element 1.

The control signals supplied to the scan driver 21 and the data driver 22 from the control signal generating unit 42 include a pulse polarity control signal CS2 for controlling by inverting the polarity of the pulse voltage, for example, applied to the display element 1, a frame start signal CS3 indicating the start of the image in one frame, a data latch scan shift signal CS4 for controlling the synchronism of the line with the data stored by the data driver 22 and the line selected by the scan driver 21, and a driver output cut-off signal CS5 for cutting off the output of the data driver 22 and the scan driver 21. Also, a data retrieving clock signal CS1 for sequentially retrieving the data of one line is supplied to the data driver 22 from the control signal generating unit 42.

The display element drive method according to the embodiment is implemented by properly designing the sequence in the control circuit 4 for controlling the display contents.

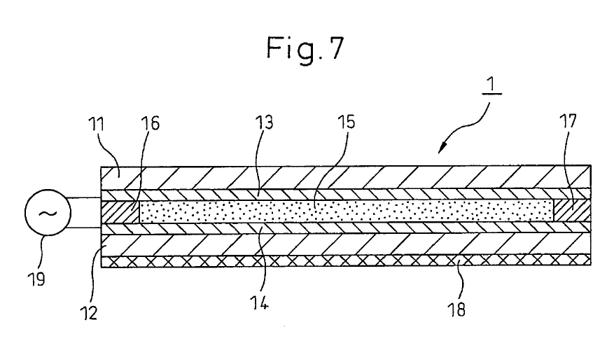

FIG. 7 is a sectional view schematically showing an example of the display element (liquid crystal display element) shown in FIG. 6. In FIG. 7, reference numerals 11, 12 designate a film substrate, 13, 14 a transparent electrode (ITO, for example), 15 a liquid crystal composition (cholesteric liquid crystal), 16, 17 a seal member, 18 a light absorption layer and 19 a drive circuit.

The display element 1 includes the liquid crystal composition 15, and the transparent electrodes 13 and 14 crossing each other at right angles are formed on the inner surface (the surfaces for sealing the liquid crystal composition 15) of the transparent film substrates 11, 12, respectively. Specifically, the film substrates 11, 12 are formed with a plurality of scan electrodes 13 and a plurality of data electrodes 14 in a matrix. Incidentally, the scan electrodes 13 and the data electrodes 14 are drawn in FIG. 7 in the same manner as if they are parallel to each other. Actually, however, each scan electrode 13 of course is crossed by a plurality of the data electrodes 14. Further, the thickness of each film substrate 11, 12 is, for example, about 0.2 mm, and the layer thickness of the liquid crystal composition 15 is, for example, about 3 μm to 6 μm. For simplicity of explanation, however, the ratio between these figures is ignored.

The electrodes 13, 14 are desirably coated with an insulating film or an orientation stabilizing film. Also, a visible light absorption layer 18 is formed, as required, on the outer surface (back surface) of the substrate (12) far from the side entered by the light.

According to this embodiment, the liquid crystal composition 15 is the cholesteric liquid crystal assuming the cholesteric phase at room temperature. These materials and the combination thereof are specifically explained below with reference to a test example.

The seal members 16, 17 are intended to seal the liquid crystal composition 15 between the film substrates 11 and 12. Incidentally, the drive circuit 19 is for applying a predetermined pulse-like voltage to the electrodes 13, 14.

Although the film substrates 11, 12 are both translucent, at least one of the substrates in pair usable as a display element 1 according to this embodiment is required to be translucent. Incidentally, a glass substrate can be taken as an example of a translucent substrate. Nevertheless, substrates of PET, PC or the like flexible resin film can be used other than the glass substrate. Although ITO (indium tin oxide) is a typical material of the electrodes 13, 14, a transparent inductive film of such a material as IZO (indium zinc oxide), a metal electrode of aluminum or silicon, or a photoconductive film of such a material as amorphus silicon or BSO (bismuth silicon oxide) may also be used.

In the liquid crystal display element shown in FIG. 7, as described above, a plurality of parallel band-like transparent electrodes 13, 14 are formed on the inner surface of the transparent film substrates 11, 12 in opposed relation to each other at right angles to each other as viewed from the direction perpendicular to the substrates.

The display element according to the embodiment may be formed with an insulating film having the function of preventing the shorting between the electrodes or improving the reliability of the liquid crystal display element as a gas barrier layer. Also, an organic material such as polyimide resin, polyamide-imide resin, polyether-imide resin, polyvinyl butyral resin or acryl resin or an inorganic material such as silicon oxide or aluminum oxide can be taken as an example of the material for the orientation stabilizing film. Incidentally, the orientation stabilizing film coated on the electrodes 13, 14 can double as an insulating film.

The display element according to the embodiment may include a spacer arranged between the pair of the substrates to hold a uniform gap between the substrates. A spherical object F of resin or an inorganic oxide may be employed as an example of this spacer. Also, a fixed spacer having the surface coated with thermoplastic resin may also be suitably used.

The liquid crystal composition (liquid crystal layer) 15 is formed of such a material as a cholesteric liquid crystal containing a nematic liquid crystal composition to which 10 to 40 wt % of chiral agent is added. The amount of the chiral agent added is a value assuming that the total amount of the nematic liquid crystal component and the chiral agent is 100 wt %.

The conventionally well-known various nematic liquid crystals can be used. Nevertheless, the dielectric anisotropy of at least 20 is desirable for the purpose of the drive voltage. Specifically, the dielectric anisotropy of 20 or more comparatively reduces the drive voltage. Also, the cholesteric liquid crystal composition desirably has the dielectric anisotropy (Δε) of 20 to 50. In this range, a multipurpose driver is substantially usable.

Also, the refractive index anisotropy (Δn) is desirably 0.18 to 0.24. A value smaller than this range would reduce the reflectivity in the planar state, while a value larger than this range would increase the scattered reflection in the focal conic state and would be accompanied by an increased viscosity for a reduced response rate. Also, the thickness of the liquid crystal is desirably about 3 μm to 6 μm. A smaller value would reduce the reflectivity in the planar state, while a larger value than this range would result in an excessively high drive voltage.

A QVGA display element 1 of size A4 having the aforementioned configuration was fabricated. This display element 1 has a three-layer laminated structure exhibiting the reflection colors of RGB and is capable of substantially full-color display.

In this configuration, the B (blue), G (green) and R (red) layers are stacked desirably in that order as viewed from the direction of observation. In the case where the polarization of the reflected light of G arranged as a middle layer is opposite to that of B and R, the reflection efficiency is further improved desirably. Specifically, in the case where B and R reflect the right circularly polarized light, G is desirably left circularly polarized, while in the case where B and R reflect the left circularly polarized light, on the other hand, G is desirably right circularly polarized. The polarization of these reflected light can be controlled with the chiral agent formed of R-enatiomer or S-enatiomer (L-enatiomer).

A large-sized display element was test fabricated by arranging the eight color QVGA elements described above in tiles. In the process, the RGB layers are configured to share a scan driver thereby to suppress the cost increase correspondingly. A multipurpose STN driver is used as the driver IC, and the 320 outputs (two driver ICs of 160 outputs) are used on data side while 240 outputs (one driver IC of 240 output) is used on scan side thereby to make up a drive circuit.

At the same time, the voltage input to the driver is desirably stabilized, as required, by the voltage follower of the operational amplifier. A cell is used for the battery.

The display element described above was used for both the conventional drive method and the drive method according to the embodiment.

First, the display element described above was driven by the conventional sequence. Then, a surge current of about 800 mA flowed, and the current supply of the battery was overtaken by this overcurrent, resulting in a low-quality display of a contrast greatly different from the original contrast.

The display element described above was next driven by the sequence according to the embodiment. Then, the surge current was suppressed to not more than 300 mA, and the drive voltage was also stable, thereby realizing the original display quality.

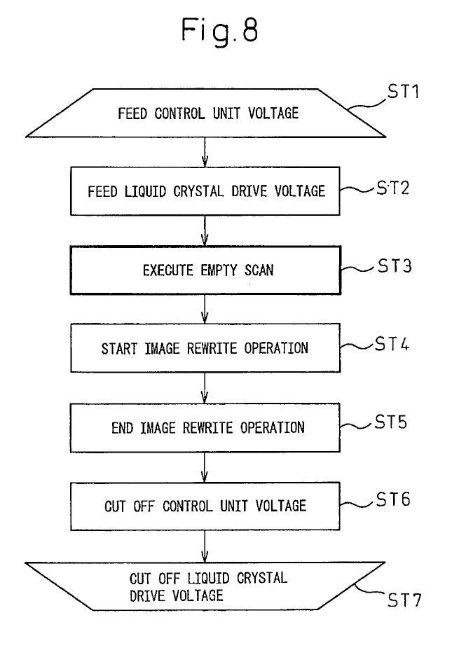

FIG. 8 is a flowchart for explaining an example of the display element drive method according to the embodiment.

As shown in FIG. 8, first, the control unit voltage is fed in step ST1, after which the liquid crystal drive voltage is fed in step ST2, and further, the empty scan of the scan driver is carried out in step ST3. After that, the process proceeds to step ST4 to start the image rewrite (write) operation. Specifically, the unstable state of the scan driver after throwing on power is eliminated by carrying out the empty scan before starting the rewrite operation.

In executing the empty scan in step ST3, the image data is allowed to be unstable, and therefore, the image data input process is not specifically required. In other words, even in the case where the image data is unstable (random), the voltage output for empty scan is kept at a threshold value or less, and therefore, the display quality is not affected at all.

Then, the process proceeds to step ST6 and after complete image rewrite operation, the control voltage is cut off in step ST6 and so is the liquid crystal drive voltage.

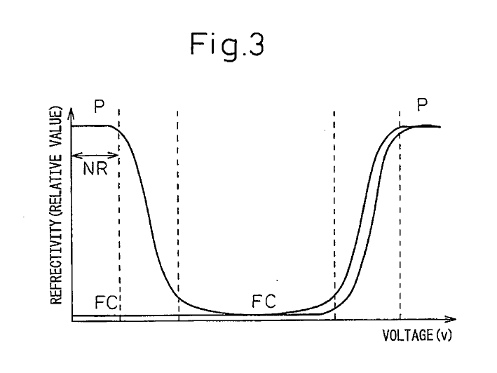

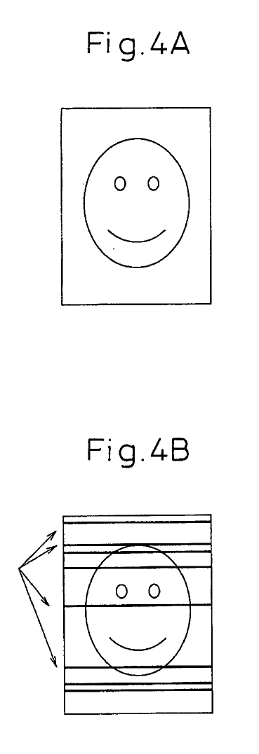

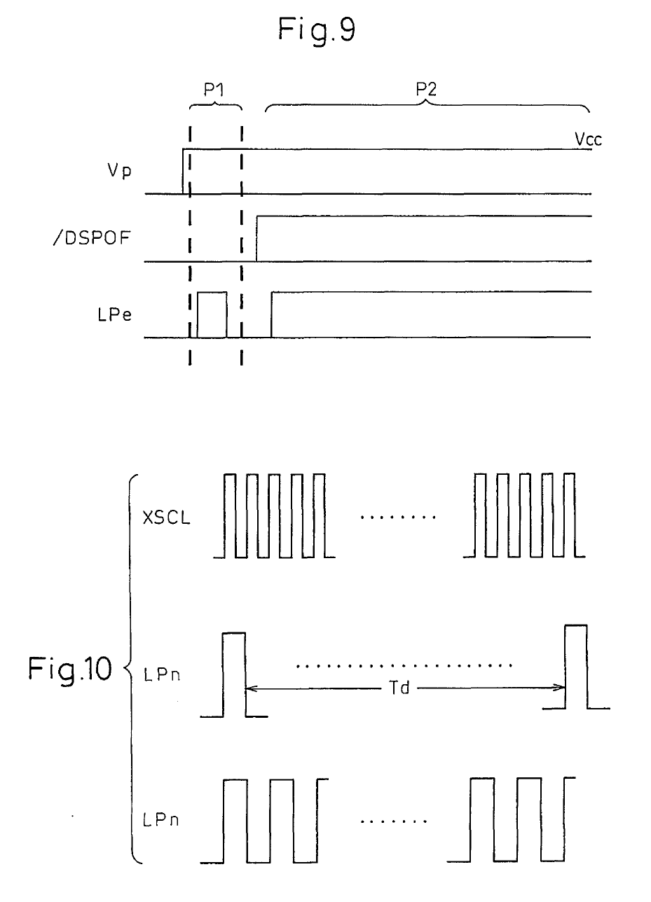

In the process described above, the empty scan in step ST3 may be carried out in the area NR having not any response shown in FIG. 3, for example. Preferably, however, as shown in FIG. 9, the function, if any, of the driver to cut off the voltage output (normally, controlled by DSPOF), is utilized to entirely turn off the voltage for driving the display medium, thereby effectively saving the power.

FIG. 9 is a diagram showing the control signal in an example of the display element drive method according to the embodiment, or how to use the function of cutting off the driver voltage output at the time of empty scan in step ST3 shown in FIG. 8.

In the case where the source voltage Vp comes to assume Vcc with power thrown on as shown in FIG. 9, the signal/DSPOF is reduced to low level “L” in the surge current suppression phase P1 and the driver output is cut off. In this surge current suppression phase P1, the data latch scan pulse signal LPe is output by one frame, for example, and the empty scan of the scan driver is carried out. Incidentally, in the next write phase P2, the image write (rewrite) process is executed as in the prior art.

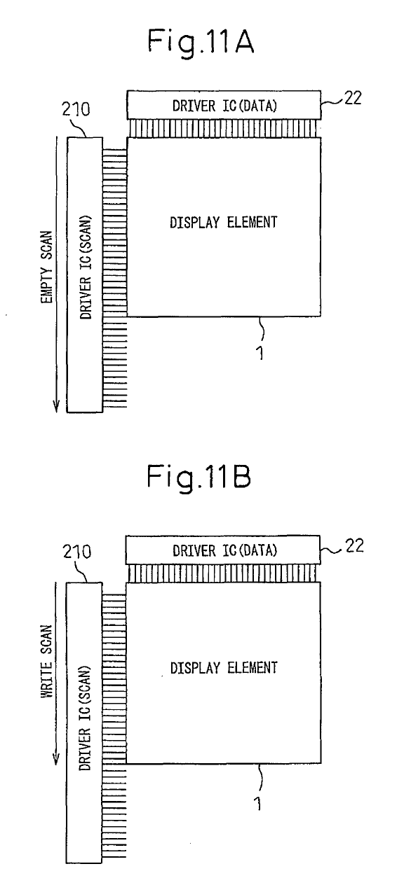

FIG. 10 is a diagram for explaining the scan pulse signal in the display element drive method according to the embodiment. In FIG. 10, reference character XSCL designates a driver clock for data retrieval, LPn a scan pulse for the normal write operation, and LPc a scan pulse for the empty scan.

As shown in FIG. 10, during the normal write operation, the data corresponding to the next-selected scan electrode is retrieved by the data driver in accordance with the driver clock XSCL during the time Td when the scan driver selects one scan electrode. In synchronism with the selection of the scan electrode, a data pulse (voltage output) is applied to each of a plurality of data electrodes from the data driver.

In this case, the interval (Td) between the scan pulses LPn for the normal write operation is, for example, about several hundred μsec to several msec, while the interval of the scan pulses LPe for the empty scan is preferably not more than 1 μsec (say, several hundred nsec). Specifically, during the normal write operation, the time for writing the data of one scan line or the time Td (substantially equal to the interval of the scan pulse LPn) required to retrieve the data of the next one scan line is as long as several hundred μsec to several msec (low in speed), while the interval of the scan pulse LPe for the empty scan is preferably as short as not more than 1 μsec (high in speed) equivalent to the STN liquid crystal display element.

As a result, the image write (rewrite) process similar to the prior art can be executed without being conscious of the waiting time due to the empty scan on the part of the user. According to this embodiment, the empty scan eliminates the unstable state of the shift register of the scan driver and hence the extraneous electrode selection, thereby making it possible to avoid the flow of a large surge current.

FIGS. 11A to 14 are diagrams for explaining the second to fifth embodiments of the scan driver according to the embodiment.

FIGS. 11A and 11B are diagrams for explaining the scan driver according to a second embodiment, in which FIG. 11A shows the empty scan process and FIG. 11B the normal image write process.

As shown in FIGS. 11A and 11B, the scan driver 210 according to the second embodiment has control terminals greater in number than the scan electrodes in the display element 1.

As shown in FIG. 11A, in the scan driver 210 according to the second embodiment, the empty scan process is executed for all the control terminals before the image write (rewrite) operation, for example, immediately after switching on power and applying the operable logic voltage to the scan driver 210. As a result, the unstable state of all the shift registers in the scan driver 210 is obviated, and the surge current can be suppressed to a minimum at the time of starting the image write operation. In this case, all the control electrodes of the scan driver 210 are scanned (empty scan), and therefore, though required somewhat longer for the empty scan than in the third embodiment described below, no serious problem is posed.

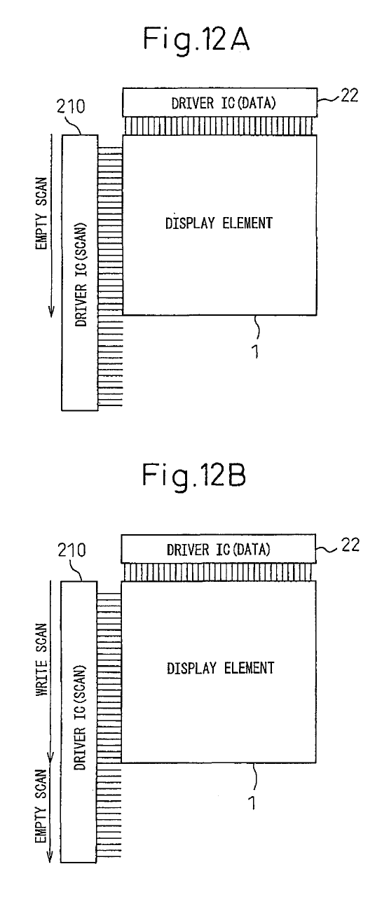

FIGS. 12A and 12B are diagrams for explaining the scan driver according to a third embodiment, in which FIG. 21A shows the empty scan process, and FIG. 12B the normal image write process.

As shown in FIGS. 12A and 12B, the scan driver 210 according to the third embodiment, like the one according to the second embodiment described above, has more control terminals than the scan electrodes in the display element 1.

As shown in FIG. 12A, the empty scan process by the scan driver 210 according to the third embodiment is executed as many times as the scan electrodes in the display element 1. In the process, a part of the shift registers of the scan driver other than the control terminals corresponding to the scan electrodes in all the control terminals of the scan driver 210 remain unstable, while the surge current can be sufficiently reduced for practical purposes at the time of the image write operation. According to the third embodiment, the time required for the empty scan at the time of (before) the image write operation can be further shortened than in the second embodiment described above.

As shown in FIG. 12B, the image write process is executed in such a manner that an actual image is written by scanning as many times as the scan electrodes in the display element 1 and then the remaining control terminals of the scan driver 210 are empty scanned thereby to obviate the unstable state of all the shift registers of the scan driver. Incidentally, the image writing scan (write scan) is carried out at low speed, for example, and therefore, the time required for empty scan after the write scan at the time of actual image write operation poses substantially no problem.

As described above, the second embodiment shown in FIGS. 11A, 11B and the third embodiment shown in FIGS. 12A, 12B use the same scan driver 210 in different control operations (sequences).

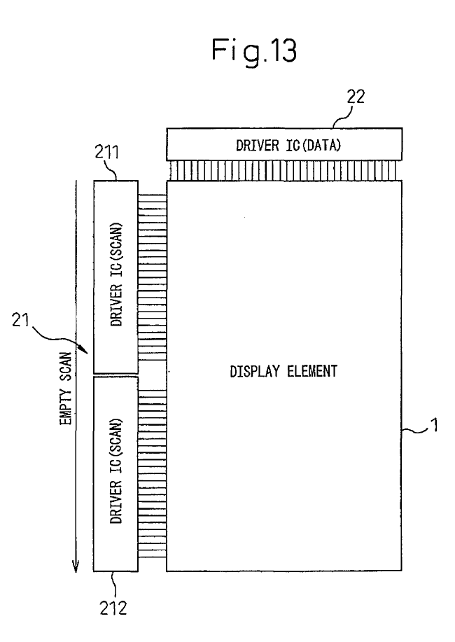

FIG. 13 is a diagram for explaining the scan driver according to a fourth embodiment.

As shown in FIG. 13, the scan driver according to the fourth embodiment is configured of two scan driver units 211 and 212 each having as many control terminals as one half of the scan electrodes of the display element 1. According to the fourth embodiment, the empty scan process is executed for all the scan electrodes sequentially by the two scan driver units 211, 212. The empty scan process using a plurality of the scan driver units (driver ICs) 211, 212 in this way, if executed for all the scan electrodes sequentially, is facilitated in a sequence similar to the actual image write process.

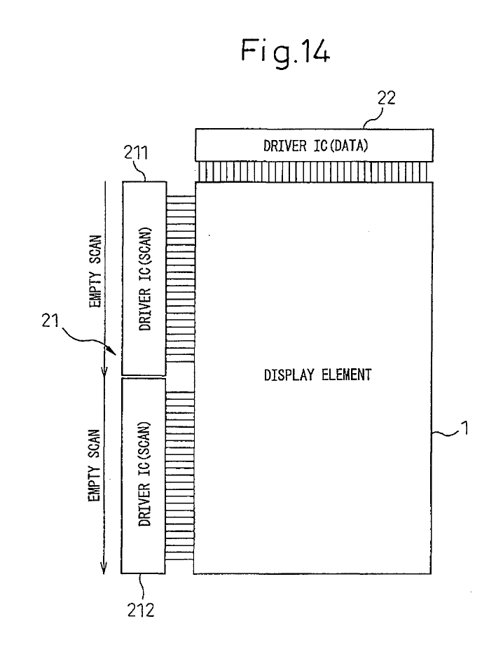

FIG. 14 is a diagram for explaining the scan driver according to a fifth embodiment.

As shown in FIG. 14, the scan driver according to the fifth embodiment, like in the fourth embodiment described above, is configured of two scan driver units 211, 212 each having as many control terminals as one half of the scan electrodes of the display element 1, and the empty scan process is executed by the two scan drivers units 211, 212 in parallel each for the corresponding one half of the scan electrodes. As a result, the time required for the empty scan process can be shortened to about one half that required in the fourth embodiment described above. Incidentally, the actual image write process, like the empty scan process shown in FIG. 12 above, is sequentially executed for all the scan electrodes of the display element 1.

Incidentally, the number of the scan driver units (driver ICs) making up the scan driver is of course not limited to 2.

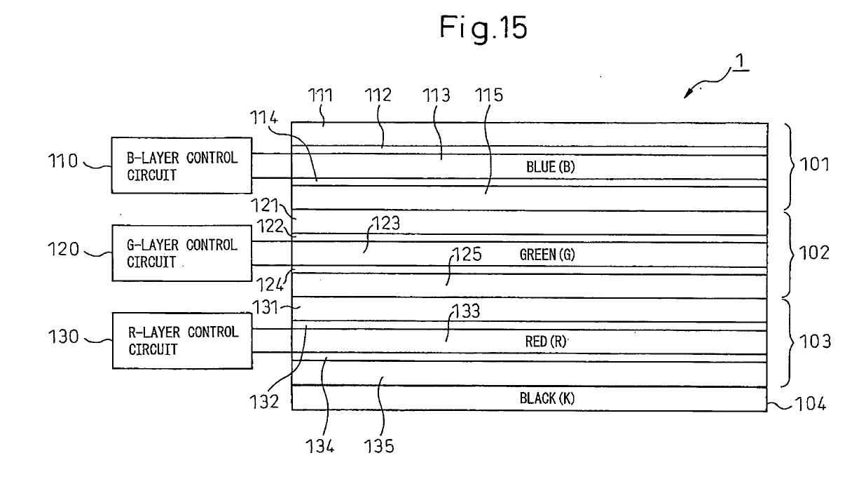

FIG. 15 is a diagram showing an example of the display element according to the embodiment. In FIG. 15, reference numeral 10 designates a blue (B) layer reflecting the blue light, 102 a green (G) layer reflecting the green light, 103 a red (R) layer reflecting the red light, and 104 a black (K) layer absorbing the light.

As shown in FIG. 15, the display element 1 has a laminated structure of the R layer 103, the G layer 102 and the B layer 101 stacked in that order on the K layer 104. The B layer 101 is configured to hold a liquid crystal 113 with substrates (film substrates) and transparent electrodes (ITO) 111, 112 and 115, 114 in opposed relation to each other. The G 102, on the other hand, is configured to hold a liquid crystal 123 with substrates and transparent electrodes 121, 122 and 125, 124 in opposed relation to each other. Similarly, the R layer 103 is configured to hold a liquid crystal 133 with substrates and transparent electrodes 131, 132 and 135, 134 in opposed relation to each other.

The transparent electrodes 112, 114 of the B layer 101 are connected to a B-layer control circuit 110, the transparent electrodes 122, 124 of the G layer 1021 are connected to a G-layer control circuit 120, and the transparent electrodes 132, 134 of the R layer 103 are connected to a R-layer control circuit 130. The transparent electrodes 112, 114; 122, 124; 132, 134 of the respective layers make up scan electrodes and data electrodes, respectively, and intersect each other in opposed relation to each other. Incidentally, in the layers 101 to 103, the scan electrodes are connected with a scan driver, and the data electrodes with a data driver. With this configuration, the display element 1 is capable of substantially full-color display.

In the aforementioned configuration, the display element 1 is configured of, for example, QVGA of size A6. The B layer 101, the G layer 102 and the R layer 103 are stacked in the same order, the liquid crystal is polarized in the same direction and the same driver is used as in the QVGA display element in size A4 described above with reference to FIG. 7. Incidentally, the control circuits (scan drivers) 130 to 110 of the layers RGB, though arranged separately from each other, can be unified to reduce the cost.

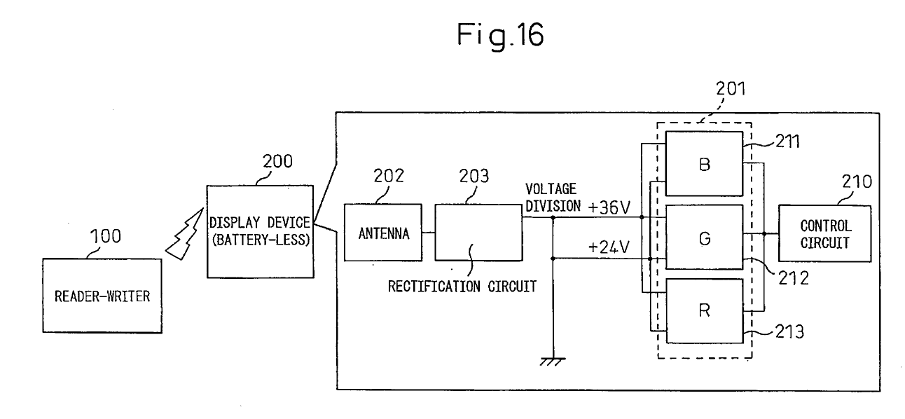

FIG. 16 is a block diagram schematically showing the electronic terminal using the display element of FIG. 15 according to another embodiment.

As shown in FIG. 16, the electronic terminal 5 (display device) 200 according to this embodiment is adapted to receive the clock CLK, the display information and the drive power through the electromagnetic wave without contact with the reader-writer (electromagnetic wave source) 100 to perform the image write (rewrite) operation. The display device 200 includes a control circuit 210 and a display element 201 having the B layer 211, the G layer 212 and the R layer 213. The control circuit 210 is equivalent to a collection of the B-layer control circuit 110, the G-layer control circuit 120 and the R-layer control circuit 130 in FIG. 15.

Incidentally, a zener diode or the like is preferably used to stabilize the voltage input to the control circuit (driver) 210 with a small power consumption.

In the display device 200 according to this embodiment, when placed airborne over the reader-writer 100, for example, the display element (display device) 201 begins the write operation, and upon complete placement of the display device 200 over the reader-writer 100, the write operation is ended and the display image is held.

As the result of placing the display device 200 shown in FIG. 16 over the reader-writer 100 and driving it in the conventional sequence, a larger surge current than the energy suppliable from the electromagnetic wave flowed, resulting in a voltage drop, and a satisfactory display could not be obtained. Specifically, the pixels which otherwise should assume the planar state failed to assume the planar state due to the voltage drop, thereby leading to a dark display much lower in quality than the original contrast.

The use of the display element drive method according to the embodiment, in contrast, substantially suppressed the surge current even immediately after placing the display device 200 over the reader-writer 100, and the drive voltage was so stable as to realize the original display quality.

In the battery-less display device described above, depending on the performance of the driver used, the empty scan rate of about 1 μsec/line or less (for example, several hundred nsec/line) is possible. Also, the image write operation rate of several msec/line or more is common. Incidentally, the ratio of the empty scan rate to the image write operation speed, though changeable with various conditions, is preferably not less than 100 from the viewpoint of the balance with the waiting time required for the empty scan.

As described above, the display element according to the embodiment can be used also with the battery-less display device 200 for wirelessly receiving the power and the display information (write image data) from the reader-writer without any battery as shown in FIG. 16. Specifically, according to the embodiment, the empty scan is executed before starting the image write operation by receiving the power and the image data from the reader-writer 100. In this way, the unstable state of the scan driver can be obviated, thereby making it possible to execute the image write operation while at the same time preventing a large surge current flow.

According to the embodiment, there can be provided a display element drive method, a display element and an electronic terminal which are applicable to all the display elements for performing the write operation at low speed not only for the cholesteric liquid crystal but also for the still image display such as the electronic paper on the one hand, and by suppressing a large surge current which otherwise might be generated immediately after the image write operation, the user of an inexpensive multipurpose driver and the driver with battery are made available, thereby making possible the power saving and stable display quality on the other hand.

1. A method of driving a display element including a plurality of scan electrodes and a plurality of data electrodes intersecting in opposed relation to each other for selecting the scan electrodes in a predetermined order and executing an image writing process, wherein
an empty scan process for said scan electrodes is executed before said image writing process.

2. The display element drive method as claimed in claim 1, wherein
said image writing process is executed by applying a pulse-like drive voltage to a display medium between said selected scan electrode and said plurality of data electrodes.

3. The display element drive method as claimed in claim 2, wherein
said empty scan process is such that a voltage output applied to said display medium is not higher than a response value voltage of said display medium.

4. The display element drive method as claimed in claim 3, wherein said empty scan process is such that a voltage output of a data driver for driving said plurality of data electrodes is in an unstable state.

5-6. (canceled)

7. The display element drive method as claimed in claim 1, wherein said employ scan process is executed immediately after applying an operable logic voltage to a scan driver for sequentially selecting said plurality of scan electrodes.

8. The display element drive method as claimed in claim 1, wherein a scanning rate of said empty scan process is higher than a scanning rate in said image writing process.

9-12. (canceled)

13. The display element drive method as claimed in claim 1, wherein
a scan driver for sequentially selecting said plurality of scan electrodes and a data driver for driving said plurality of data electrodes are each a multipurpose driver.

14. The display element drive method as claimed in claim 13, wherein
said scan driver includes at least as many control terminals as said scan electrodes, and said empty scan process is executed as many times as said scan electrodes.

15. The display element drive method as claimed in claim 14, wherein
said scan driver, after executing said empty scan process as many times as said scan electrodes, executes an actual image writing process by scanning as many times as said scan electrodes, followed by executiing the empty scan for the remaining control terminals.

16. The display element drive method as claimed in claim 13, wherein
said scan driver has at least as many control terminals as said scan electrodes, and said empty scan process is executed for all the control terminals of said scan driver.

17-18. (canceled)

19. A display element comprising a plurality of scan electrodes and a plurality of data electrodes intersecting each other in opposed relation to each other, said scan electrodes being selected in a predetermined order by a scan driver, said data electrodes executing an image writing process with a data signal supplied by a data driver in correspondence with the selected scan electrodes, wherein
said scan driver executes an empty scan process for said scan electrodes before said image writing process.

20. The display element as claimed in claim 19, wherein
said image writing process is executed by applying a pulse-like drive voltage to a display medium between a scan electrode selected by said scan driver and a plurality of data electrodes driven by said data driver.

21. The display element as claimed in claim 20, wherein
said scan driver and said data driver output a signal in which a voltage applied to said display medium is not higher than a response value voltage of said display medium in said empty scan process.

22. The display element as claimed in claim 21, wherein
said data driver outputs a signal for instabilizing an output of said data driver in said empty scan process.

23-24. (canceled)

25. The display element as claimed in claim 19, wherein
said scan driver executes said empty scan process immediately after applying an operable logic voltage to said scan driver.

26. The display element as claimed in claim 19 wherein
said scan driver executes said empty scan process at a scan rate higher than that for said image writing process.

27-30. (canceled)

31. The display element as claimed in claim 19, wherein
said scan driver and said data driver are each a multipurpose driver.

32. The display element as claimed in claim 31, wherein
said scan driver has at least as many control terminals as said scan electrodes and executes said empty scan process as many times as said scan electrodes.

33. The display element as claimed in claim 32, wherein
said scan driver, after executing the empty scan as many times as said scan electrodes, executes an actual image writing process by scanning as many times as said scan electrodes, followed by executing the empty scan for the remaining control terminals.

34. The display element as claimed in claim 31, wherein
said scan driver has at least as many control terminals as said scan electrodes, and executes said empty scan process for all the control terminals of said scan driver.

35-38. (canceled)
